(19) United States
(12) Patent Application Publication
(10) Pub. No.: US 2016/0148327 A1
(43) Pub. Date: May 26, 2016

(54) INTELLIGENT ENGINE FOR ANALYSIS OF INTELLECTUAL PROPERTY

(71) Applicant: conaio Inc., Menlo Park, CA (US)

(72) Inventor: Rolf Buchholz, Wedel (DE)

(73) Assignee: conaio Inc.

(21) Appl. No.: 14/552,232

(22) Filed: Nov. 24, 2014

(51) Int. Cl. G06Q 50/18; G06Q 10/00; G06N 7/00; G06F 17/30; G06N 99/00

(52) U.S. Cl. CPC G06Q 50/184; G06F 17/30601; G06F 17/30401; G06F 17/30528; G06N 99/005; G06N 7/005; G06Q 10/00

(57) ABSTRACT

An intelligent intellectual property (IP) engine (IIPE) retrieves IP-related data from public or proprietary IP databases. Public IP databases include, for example, Espacenet, USPTO, EPO and other websites. IP-related data may be, for example, patents, non-patent literature, R&D information. The retrieved IP-related data is processed to structure, visualize, analyze and interpret the data in an individual context, thereby enabling users to make operational and strategic business decisions.

### BACKGROUND OF THE INVENTION

1. Field of the Invention

The present invention relates to handling and contextual analysis of large data sets. In particular, the present invention relates to handling and contextual analysis of large data sets involving large data sets related to intellectual property (IP).

2. Discussion of the Related Art

Systems that allow user access of large data sets (e.g., enterprise-wide information and content management systems and databases) are becoming more available, such as that described in IBM Content Analytics with Enterprise Search, Version 3.0, copyrighted IBM Corporation, 2012.

### SUMMARY

According to one embodiment of the present invention, an intelligent intellectual property (IP) engine (IIPE) retrieves IP-related data from public or proprietary IP databases. Public IP databases include, for example, Espacenet, USPTO, EPO and other websites. IP-related data may be, for example, patents, trademarks, non-patent literature, R&D information. The retrieved IP-related data is processed to structure, visualize, analyze and interpret the data in an individual context, thereby enabling users to make operational and strategic business decisions.

The present invention is better understood upon consideration of the detailed description below in conjunction with the accompanying drawings.

### BRIEF DESCRIPTION OF THE DRAWINGS

FIG. 1 shows a software architecture of intelligent IP engine 100, according to one embodiment of the present invention.

FIG. 2 is FIG. 2A and FIG. 2B taken together and shows one exemplary presentation of the clustered results, in accordance with one embodiment of the present invention.

FIG. 3 shows a functional architecture of application program 301 supported by intelligent IP engine 100, according to one embodiment of the present invention.

### DETAILED DESCRIPTION OF THE PREFERRED EMBODIMENTS

According to one embodiment of the present invention, an intelligent processor of IP-related data (“intelligent IP engine” or “IIP engine”) may be implemented in a computer system using one or more conventional computers. As an example, in one implementation, such a computer may include a conventional microprocessor (e.g., an Intel Core2 Duo microprocessor with a processing speed exceeding 2.5 GHz), supported by 6 GB memory and a storage device having a storage capacity of 250 GB. The computer may run a conventional operating system (e.g., a Linux-based operating system), and may include a database management system (e.g., MySQL) and one or more web servers (e.g., Apache 2.x). A high performance and scalable implementation of the computer system would allow results to be returned with sufficient bandwidth for interactive use, suitable for cloud computing or other hyper converged infrastructure.

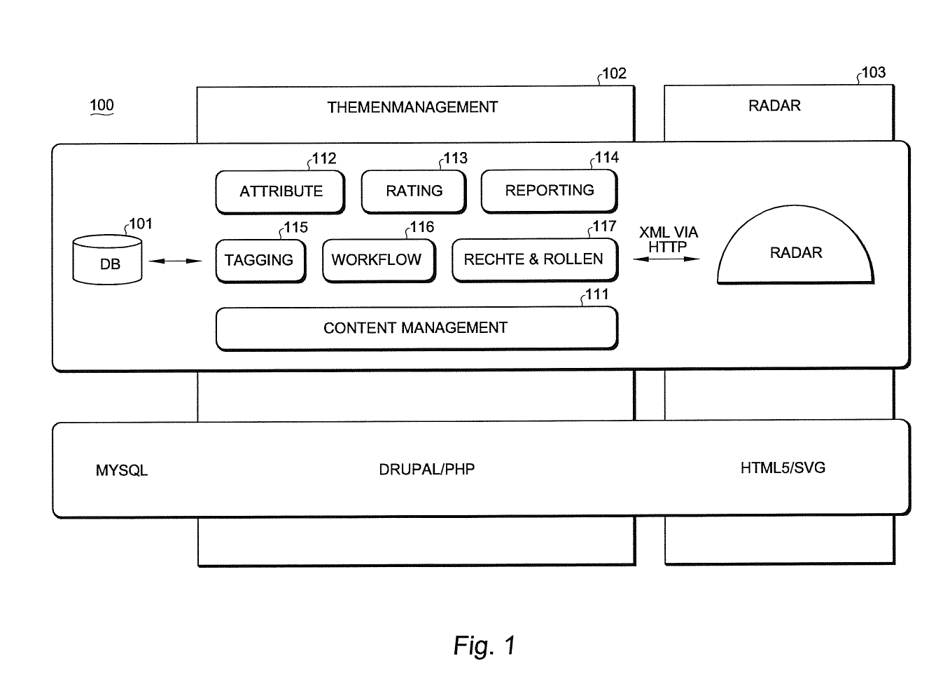

FIG. 1 shows software architecture intelligent IP engine 100, according to one embodiment of the present invention. As shown in FIG. 1, IIP engine 100 includes database 101, topics management system 102 and analysis or “trend radar” system 103. Database 101 may be organized, for example, as a MySQL database. The data in the database may be retrieved and presented at a higher level by topics management system 102, implemented by a content management system, such as Drupal. The organized data in topics management system 102 may be accessed, processed and displayed by analysis system 103 using, for example, a hypertext marked-up language (e.g., an XML script) over the hypertext transport protocol (HTTP). As shown in FIG. 1, topics management system 102 system includes content management system 111 (e.g., Drupal), attribute module 112, rating module 113, reporting module 114, tagging module 115, workflow module 116 and access control module 117. Attribute module 112 provides for management of data object definitions (e.g., defining the individual topics). Rating module 113 provides for association of quantitative values (e.g., statistical measures) with data objects which may be useful for data analysis. Reporting module 114 presents data for user viewing or visualization. Tagging module 115 provides for association of data objects with textual or non-textual metadata. Workflow module 116 provides for creation and maintenance of data processing procedures. Access control module 117 provides for security in accessing the data objects of topics management system 102.

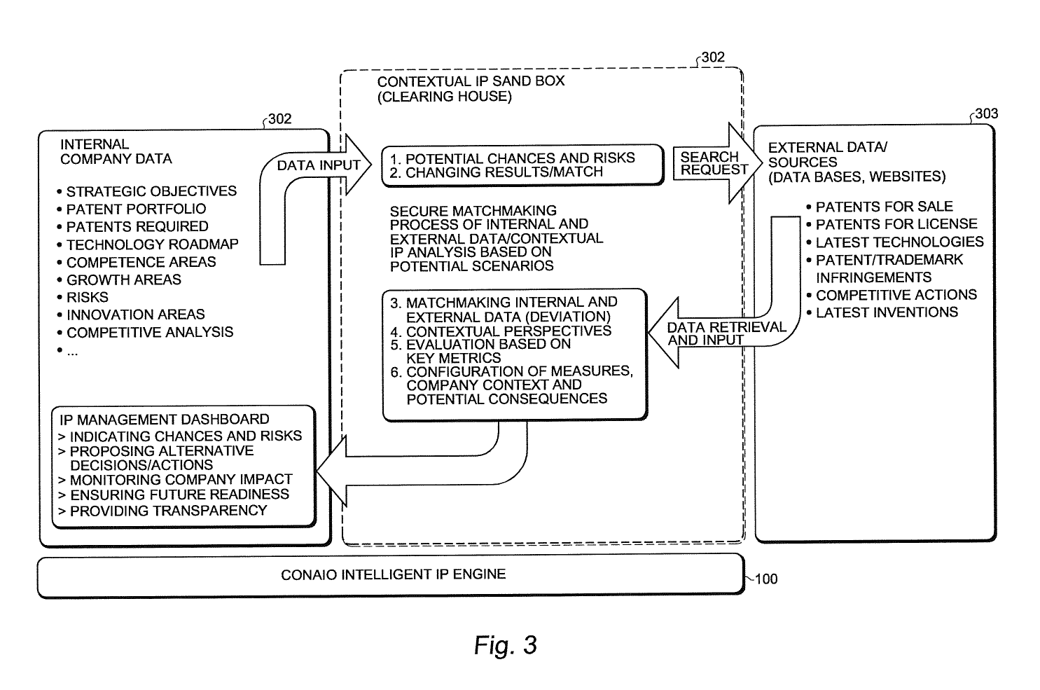

FIG. 3 shows a functional architecture of application program 301 (“Contextual IP Sand Box”) supported in IIP engine 100, in accordance with one embodiment of the present invention. As shown in FIG. 3, application program 301 accesses internal data sources 302 and external data sources 303. Typically, internal data sources 302 constitute a secured database in which an enterprise stores its IP related data and information. For example, internal data sources 302 include complete records of the enterprise's patent and trademark portfolios. In addition, internal data sources 302 may also include information and data relating to the enterprise's areas of competence, technology, trade secrets, know-hows, technology roadmaps, risk areas, growth areas, innovation areas, competitive information and analyses, and other intellectual property related data, such as its strategic objectives, and focused areas of IP acquisitions. External data sources 303 may include sources providing information and data regarding, for example, patent applications, granted patents, IP available for acquisition or license, latest technology developments, patent and trademark infringement actions, and competitive actions. The data in internal data sources 302 are preferably refreshed or updated regularly (e.g., once a day). According to one embodiment of the present invention, external data sources 303 may include public databases or websites, such as Espacenet, United States Patent and Trademark Office (USPTO), and the European Patent Office (EPO). In addition, external data sources 303 may also include other multilingual sources (e.g., websites, forums, blogs and professional journals, and global IP marketplaces) that provide structured and unstructured content.

Based on changes or new data in internal data sources 302 (e.g., updates on potential risk factors or corporate opportunities), application program 301 may access external data sources 303 to match the changes or new data with data from external data sources 303 to allow, for example, contextual analysis of opportunities and risks based on the changes or new data and the external data. Some changes of relevance include: competitive activities, new patent applications, acquisition or dispositions of assets in the IP portfolios, new development in technology, and potential infringement of IP rights. A contextual analysis may be based, for example, on contextual perspectives adopted by the enterprise, various quantitative measures (“metrics”), and potential actions that can be taken or potential consequences relevant to the enterprise. The results of the contextual analysis would be made available to management within the enterprise. Application program 301 implements suitable security measures, such that sensitive information is available only to those at suitable authorization levels.

Application program 301 may run on computer or servers in the enterprise's internal computer network. IIP engine 100 may provide significant value to other potential users, such as IP consultants, lawyers, analysts, financial and venture capital firms, and other professionals (M & A specialists). Other application programs in the IIP engine 100 may be hosted by external computer resources available to enterprises and professionals on a subscription basis. One advantage of hosting by external computer resources is to allow many enterprises to share non-proprietary information. For example, data in the external sources are made up-to-date by regular access to Espacenet, U.S. Patent and Trademark Office, Depatisnet, or other data sources, which would be available to all subscribing enterprises.

Using IIP engine 100, a user may perform, for example, a patent search of public or proprietary databases and information sources (e.g., blogs or specialist websites). For such searches, IIP engine 100 may provide semantic search interfaces that are capable of handling multiple languages and which allow the search to take advantage of built-in contextual information and proximity. Tools, such as advanced filters, are provided to further refine the search results by searching within the results (e.g., drilling down and refining context relevance), to reduce complexity. The search results may be automatically processed for use, for example, in white-spot identification and visualization, key criteria monitoring, and automated alert systems. The data retrieved by the search is further analyzed and organized by topics management system 102. Results, such as patent biographical data, or full-text specification, may also be served for user viewing using any suitable format (e.g., TXT, XML or PDF). In one implementation, the results are presented in a table form. A user may select a hypertext link to a search result for further information or more detailed viewing. The user may also download, where appropriate, an original document uncovered by the search (e.g., in PDF format).

Search queries or results may be saved and re-visited at a later time. In one embodiment, queries are stored with the search sources used and the keywords. A user may tag a search query with a comment, to allow the user to memorialize for later reference, for example, the circumstance or the purpose of the search, or any other information the user may deem useful. The integrity of the stored queries is maintained by access control system 117, requiring administrator privilege to modify or delete a stored query. The user may limit the websites that should be included in subsequent searches. IIP engine 100 handles web pages provided in numerous languages. In one implementation, IIP engine 100 handles web pages in German, Spanish, English, Chinese, Russian and French. In addition, the user or the system may specify the number of results to be incorporated from each website category or each patent search. A website category may consist, for example, of a maximum of 30 different websites. A user may also exclude, for the purpose of a given search, one or more specific website categories.

In one embodiment, the search results are processed and analyzed in analysis system 103 using a document clustering algorithm, such as Lingo. (A detailed description of the exemplary Lingo document clustering algorithm may be found, for example, at A Concept-driven Algorithm for Clustering Search Results, by Stanilaw Osinski and Dawid Weiss, published in the IEEE Intelligent Systems, May/June 3 (vol. 20), 2005, pp. 48-54). The clustering algorithm may incorporate as source information dictionaries, thesauri, and individual customer taxonomies and keywords.

In one embodiment, the results of the clustering algorithm may be viewed by the user using one or more display methods, such as “tag cloud”, “foam tree” or “circles”. The user may select a cluster member, which triggers filtering of the results embodied in the cluster member. This filtered result may be displayed, for example, as a list, with each element of the list being shown according to attributes “title”, “link” and “executive summary.” The link attribute provides, for example, access to the document uncovered by the search.

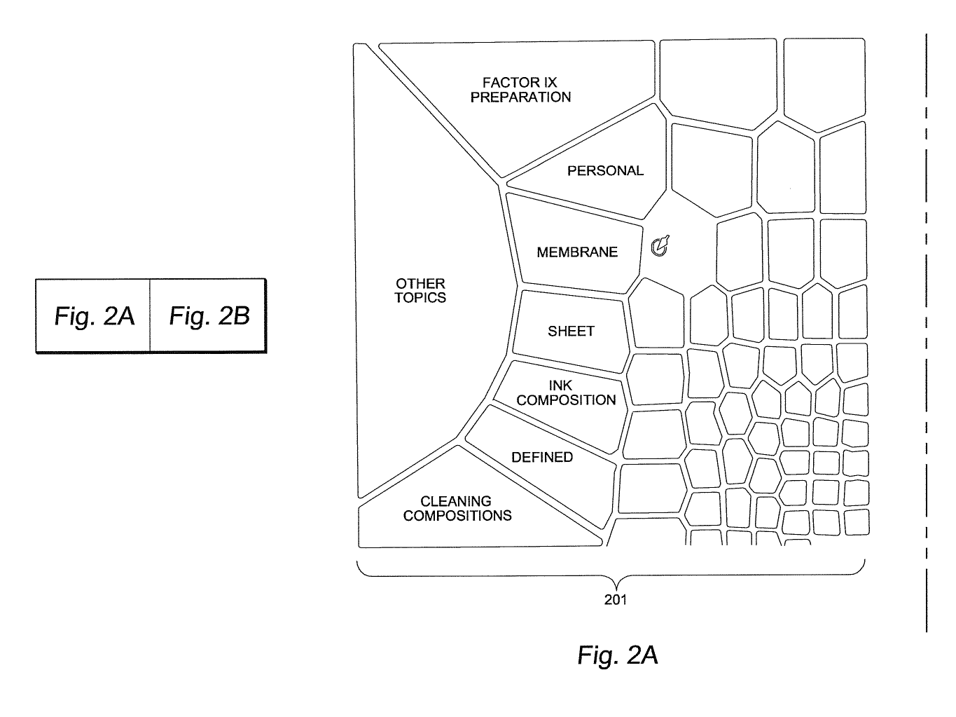

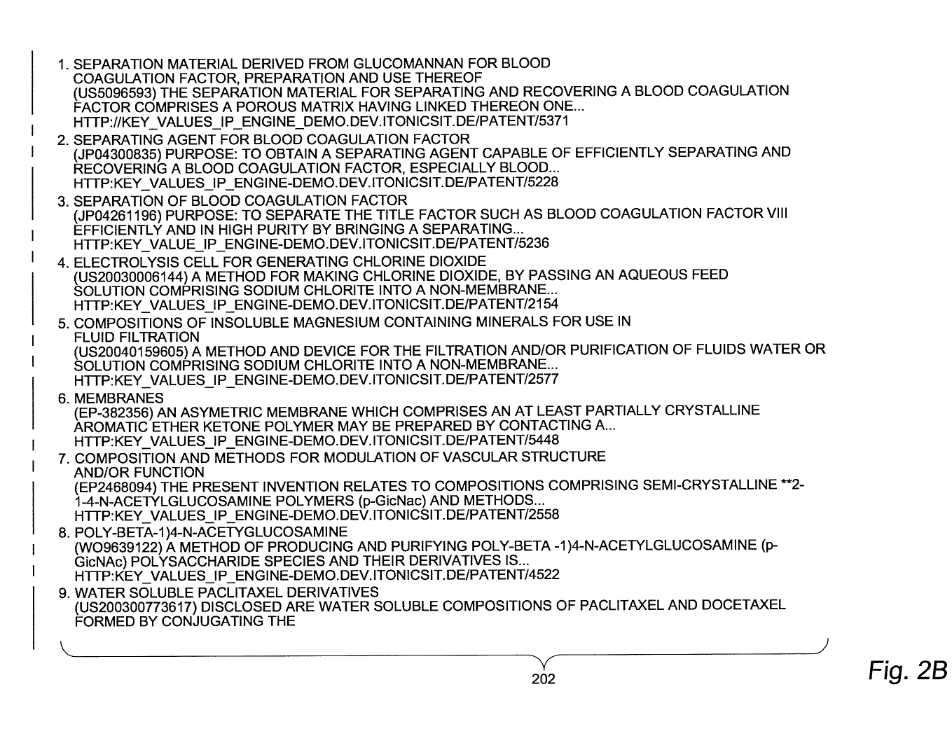

FIG. 2A and FIG. 2B show one exemplary presentation of the clustered results, in accordance with one embodiment of the present invention. As shown in FIG. 2 A and FIG. 2B, the exemplary presentation presents clusters 201 (in the “foam tree” format) resulting from application of the document clustering algorithm on a search result. The user's selection of any of the clusters in cluster 201 results in reporting module 114 reporting filtered result 202, which is shown to the right of clusters 201. Filtered results 202 show each element of the list according to attributes “title”, “link” and “executive summary.” The filters may be based on multi-variable filtering techniques, as applied to research and development data.

Based on the contextual analysis (discussed in further detail below) on the information retrieved, the user may be presented visualizations of complex data relationships, such as clustering, grouping, tag clouds, landscapes and other suitable techniques.

Analysis system 103 may apply other contextual analytics on the IP data in database 101, including data extracted from external databases and websites searched by IIP engine 100. The methods that can be applied by analysis system 103 may include topic modeling, content analytics, natural language processing, principal component analysis (PCA), TRIZ¹ and reverse TRIZ. In one implementation, the contextual analysis may be performed using topics defined from a vocabulary, a chemical or physical structure or description, a field of application, a research topic, an inventor or a patent holder. An example of such contextual analysis may be, for example, the techniques described in Probabilistic Topic Models, by David M. Blei, published in Communications of the ACM, April 2012, vol. 55, No. 4, pp. 77-84. ¹TRIZ refers to the techniques used in a problem-solving, analysis and forecasting tool derived from the study of patterns of invention in the global patent literature by Soviet inventor Genrich Altshuller and his associates.

In analysis system 103, semantic clustering of data sets uses techniques including clustering and statistical measures. Analysis system 103 may provide integrated methods on platforms or tools to allow viewing of data subsets sorted by region, statistical criteria, topics, inventor, patent holder, and time span. The user may also be provided programmable tools to store automated workflows (which may be user-defined) in workflow module 116 that include application steps of analytics. The workflows may include steps based on supervised learning and applications of user-defined priorities and prior probabilities. The automated workflows may also perform analytics based on techniques such as semantic clustering of existing clusters, machine learning and Bayesian Modeling. In addition, the analytics may also apply user-defined cut-offs and contextual relationships among the topics.

Over time, based on previous queries, analysis system 103 may adaptively learn the user's core IP content in database 101, and will be able to provide recommendations, insights or advice needed for corporate decisions on competitive activities, IP opportunities and potential infringements.

In addition, based in the core IP, IIP engine 100 will be able to (a) identify patents that disclose subject matter close to the core IP to allow competitive analysis and monitoring; (b) identify patents that relate to the subject matters of the core IP to suggest areas for innovation and growth; and (c) identify new application areas for the subject matters of the core IP. These capabilities may be achieved using keywords and strings of keywords, or applying a topic modeling algorithm or other suitable content analytic techniques over the content. The data in the content database relevant to these capabilities include technical objectives, roadmaps, existing IP portfolios, external competitive and comprehensive patents, patents that are licensed or available for purchase, latest results of research and development, and other technical analysis and information. Analysis may include matching of related data, relevance rating, and impact assessment. PCA techniques may be used also to help reduce the complexity of the IP-related data into a contextual structure of patents and IP portfolios. Using these tools, a user can perform “white spot” analysis that highlights specific areas of particular significance from both technology and IP viewpoints.

In one embodiment of the present invention, relevant content is identified using TRIZ reverse in IIP 100 from a given set of patents, which includes patents from numerous jurisdictions worldwide. The TRIZ reverse technique may combine a “contradiction matrix” with content analytics, natural language processing and topic modeling techniques, as known to those of ordinary skill in the art. Using the TRIZ reverse technique, IIP 100 (a) identifies the patents that provide a potential solution for a given problem or task; (b) identifies from the patents a technology that can be applied to solve the problem or task; and (c) identifies an application of the identified technology to the problem or task. As an example, if a user would like to find a solution that would eliminate, reduce or prevent a given problem, the following provides the steps under TRIZ reverse:
1. Defining context-relevant keywords (e.g., eliminate, reduce, prevent, erase, delete, limit . . . ) to be used in the context analysis;
2. Creating semantic clusters as an intermediate results, based on keyword proximity (e.g., applying a topic modeling technique) and frequency distribution;
3. Applying a content analytic search across the intermediate results;
4. Refining the semantic clusters based on content meaning extracted in the content analytic search;
5. Allowing the user to prioritize and select clusters for review; and
6. Reviewing the selected patents in priority order to identify potential solution.

Workflow module 116 may include automated procedures for updating and adding of latest information to ensure real-time and dynamic performance in analysis system 103. Such updating procedures may include, for example, inventory and mapping of public databases and customer portfolios, matching of various data sets that are used for the contextual IP analysis described above. In one embodiment, automated procedures are provided to extract specific information from the worldwide patent literature, on-line technical information sources, and non-patent literature, so as to gather IP-related knowledge from around the globe. The automated procedures may also include automated applications of TRIZ and reverse TRIZ techniques to the gathered IP-related documents, contextual analysis and generation of concrete recommendations. Such analysis may identify new technologies, new application areas, new uses, new user strategies, and new business objectives. Workflow module 116 may also cluster existing clusters in a continual focusing process.

In one embodiment, analysis system 103 provides automated, pre-configured IP risk and opportunity analysis (i.e., gains and losses), based on dynamically matching internal and external data with global data that influences the client's risk and opportunity profiles.

In one embodiment, analysis system 103 identifies potential infringements through discovering content relationship among keywords in patent databases and on specific websites. A content-related matching factor is measured among the keywords, and according to which the keywords will be structured, prioritized, and visualized in an “early-warning-system”. Infringement of the client's patents by others' products or infringement of others' patents by the client's products may be indicated in this analysis. The early-warning system may be useful in providing an alert automatically when it is detected that the client's core IP may infringe upon patents owned by known patent trolls or by others. The events of expiration, express abandonment, failure to take required action (e.g., failure to pay a maintenance or annuity fee), and publication of a monitored patent or application may also trigger an alert based on information retrieved regularly from such source as, for example, the INPADOC database).

In one embodiment, the automated procedures may include generation of a “visualization dashboard” of the IP-related data (i.e., a presentation of the IP-related data in a pre-defined presentation format).

In one embodiment, IIP engine 100 provides an online workflow system and infrastructure for joint IP development between two or more entities. By sharing common technical and IP-related data, joint development partners can co-develop technology and share IP rights with others right from the beginning of the project. IIP engine 100, with its tools that allow identification and matching of potential partners, and its pre-configured Joint Development Agreements (JDAs) and Co-Working Platforms workflows and procedures, allow for global cooperation in research and development, as well as management of IP rights across companies, regions and topics.

The above detailed description is provided to illustrate specific embodiments of the present invention and is not intended to be limiting. Numerous variations and modifications within the scope of the present invention are possible. The present invention is set forth in the following accompanying claims.

I claim:

1. A system for managing data relating to intellectual property (IP-related), comprising:
a database system for storing and retrieving the IP-related data;
a content management system accessing the database system for organizing and managing the IP-related data according to categories and functions based on semantics of the IP-related data; and
an analysis system interacting with the content management system for providing tools for contextual analysis of the IP-data and for making recommendations based on results of the data analysis.

2. The system of claim 1, wherein a portion of the IP-related data is retrieved from public available on-line data sets maintained by patent offices in the world.

3. The system of claim 1, wherein a portion of the IP-related data is retrieved from on-line, multilingual sources selected from the group consisting of websites, forums, blogs, and professional publications.

4. The system of claim 1, wherein a portion of the IP-related data comprises content of thesaurus and user-provided taxonomies and keywords.

5. The system of claim 1, wherein the analysis system further comprises tools for contextual visualization of data relationships uncovered by the contextual analysis.

6. The system of claim 5, wherein the contextual visualization presents the IP-related data in landscapes, clusters, groups, or tag-clouds.

7. The system of claim 5, wherein the contextual visualization identifies proprietary content.

8. The system of claim 5, wherein the contextual visualization presents data according to one or more of: regions, statistical criteria, user criteria, topics, inventorships, patent ownerships, data relationships, data dependencies and time periods.

9. The system of claim 5, wherein the analysis provides multivariable filtering to refine the contextual visualization.

10. The system of claim 1, wherein the content management system classifies the IP-related data according to at least one of the following factors: vocabulary, chemical or physical structure or description, field of application, research topic, inventorship, IP ownership, and similarity or overlap in two or more of the factors.

11. The system of claim 10, wherein the management system classifies the IP-related data using a clustering technique, a statistical measure or both.

12. The system of claim 1, wherein the semantics of the IP-related data are determined using one or more of the following techniques: topic modeling, content analytics, natural language processing, principal content analysis (PCA), TRIZ and reverse TRIZ.

13. The system of claim 1, wherein the semantics of the IP-related data are determined using one or more of the following techniques: supervised learning, user-defined priorities, prior probabilities, semantic clustering of existing clusters, machine learning, user-defined cut-offs, and Bayesian modeling.

14. The system of claim 1, wherein the contextual data analysis provides recommendations with regards to competitive activities, IP opportunities, and potential infringements.

15. The system of claim 1, wherein the system resides in a computer system having capabilities for interactive use of cloud computing resources or converged infrastructure.

16. The system of claim 1, wherein the contextual analysis identifies a set of core IP based on patent queries.

17. The system of claim 16, wherein the contextual analysis identifies patents relevant to the set of core IP.

18. The system of claim 16, wherein the recommendations relate to areas of potential innovation and growth.

19. The system of claim 16, wherein the contextual analysis identifies one or more of: new application areas for the set of core IP, new materials, new technologies and new uses thereof.

20. The system of claim 16, wherein the analysis system makes recommendations regarding patent infringement based on identifying contextually related keywords in patent databases or on websites.

21. The system of claim 20, wherein the analysis system computes a content-related matching factor and, accordingly structure, prioritize and present for visualization, the recommendations.

22. The system of claim 20, wherein the contextual analysis maps the set of core IP to patents belonging to others.

23. The system of claim 22, wherein an alert is sent when the contextual analysis indicates in a predetermined area one or more of: potential patent infringement, filing of a new patent application and issuance of a new patent.

24. The system of claim 1, wherein the IP-related data comprises corporate objectives, technical roadmaps, existing IP portfolios, and patents belonging to competitors, patents to be licensed or bought, and research and development data.

25. The system of claim 24, wherein the content management system comprises a role-based access control system that allows access to the IP-related data.

26. The system of claim 1, wherein the contextual analysis assesses matching, relevance, and impact.

27. The system of claim 1, wherein the content management system maintains automated workflows.

28. The system of claim 27, wherein the automated workflows comprise automated procedures for updating and acquiring IP-related data.

29. The system of claim 27, wherein the automated workflows comprise performing inventory and mapping of public databases and customer portfolios.

30. The system of claim 27, wherein the automated workflows match various data sets to provide contextual IP insights and basis for corporate decisions.

31. The system of claim 27, wherein the automated workflows comprise an automated IP risk and opportunity analysis based on matching in real time the IP-related data with dynamic global data.

32. The system of claim 27, wherein the automated workflows comprise extracting from worldwide patent literature and online data sources of technical information.

33. The system of claim 1, wherein the analysis system makes recommendation on corporate strategies and business goals.

34. The system of claim 1, wherein the system includes IP-related data provided by two or more entities in a joint development effort.

35. The system of claim 34, wherein the tools support co-development of technical information and support sharing of IP rights with others.
